(19) United States
(12) Patent Application Publication
(10) Pub. No.: US 2011/0078097 A1
(43) Pub. Date: Mar. 31, 2011

(54) SHARED FACE TRAINING DATA

(75) Inventors: John M. Thornton, Kirkland, WA (US); Stephen M. Liffick, Seattle, WA (US); Tomasz S.M. Kasperkiewicz, Redmond, WA (US)

(73) Assignee: MICROSOFT CORPORATION, Redmond, WA (US)

(21) Appl. No.: 12/567,139

(22) Filed: Sep. 25, 2009

(51) Int. Cl. G06F 17/30; G06F 15/18; G06F 15/16

(52) U.S. Cl. 706/12; 709/229; 707/E17.009; 707/E17.014

(57) ABSTRACT

Face data sharing techniques are described. In an implementation, face data for a training image that includes a tag is discovered in memory on a computing system. The face data is for a training image that includes a tag associated with a face. The face data is replicated in a location in memory, on another computing system, so the face data is discoverable.

### BACKGROUND

Applications with facial recognition functionality are increasing in popularity. Users may implement these applications to search and categorize images based on faces that are identified in the images. Users may also implement these applications to identify additional information about the faces included in the image. For example, a user may implement a photography application to identify a name of a person whose face is included in an electronic picture.

Applications with facial recognition functionality typically use training images to identify faces in subject images. In this way, a user may tag a face in a training image and the application may identify other images that include that face. However, users are forced to repeat this process for each computer with facial recognition functionality.

### SUMMARY

Face data sharing techniques are described. In an implementation, face data for a training image that includes a tag is discovered in memory on a computing system. The face data is for a training image that includes a tag associated with a face. The face data is replicated in a location in memory, on another computing system, so the face data is discoverable.

In an implementation, face data is published on a network service. The face data is associated with a user account and is usable to identify a person based on a facial characteristic for a face represented by the face data. Access to the face data is controlled with a permission expression that specifies which users are permitted to access the face data to identify the person.

In an implementation, one or more computer-readable media comprise instructions that are executable to cause a network service to compare an identification for a user account with a permission expression that controls access to face data. The comparison is performed in response to a request for the face data in association with the user account. The face data includes an identification (ID) for a person whose face is represented by the face data. Face data that is made available to the user account is discovered. The ID for the person is identified when face data for a subject image matches the face data that includes the ID.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to share face data.

FIG. 2 is an illustration of a system showing publication of face data to a network service.

FIG. 3 is an illustration of a system in an example implementation showing use of a network service to identify additional information about a subject image.

FIG. 4 is a flow diagram depicting a procedure in an example implementation for sharing face data.

FIG. 5 is a flow diagram depicting a procedure in an example implementation for discovering face data shared by a user.

### DETAILED DESCRIPTION

### Overview

Applications with facial recognition functionality permit users to identify a person whose face is represented in a subject image, e.g., an electronic photograph. These applications identify the name of the person in the image by comparing face data for the subject image with face data that serves an exemplar. The face data that is used as the exemplar may include data from one or more training images in which a face is tagged with additional information about the face.

For example, the face data may include an identification (ID) for a person whose face is represented in the training images in which the ID is confirmed. Example IDs include, but are not limited to one or more of, a name of the person, an electronic mail address (email address), a member identification (member ID), and so forth that uniquely identify the person associated with the face.

Users often spend a significant amount of time manually tagging faces in order to train an application to identify faces that match the face with the ID. Thus, tagging faces may be time consuming and lead to user frustration. In addition, a user may utilize a variety of different computing systems which under conventional techniques forced the user to repeat the tagging procedure for each of the different computing systems.

Face data sharing techniques are described. In an implementation, one or more training images that are tagged are used to generate face data. The generated face data may then be used as an exemplar to identify faces in subject images. The techniques may be used to share face data based on one or more training images in which faces are tagged with additional information.

Additionally, the face data may be shared among computing systems and/or with a network service such that the user is not forced to repeat the tagging process for each system. For example, the network service may be a social network service to which the user belongs. A variety of other techniques are also contemplated to share the face data, further discussion of which may be found in relation to the following sections.

In the following discussion, an example environment and systems are first described that are operable to share face data. In addition, the example environment may be used to perform over-the-cloud facial recognition using face data that is shared. Example procedures are then described that may be implemented using the example environment as well as other environments. Accordingly, implementation of the procedures is not limited to the environment and the environment is not limited to implementation of the procedures.

Example Environment

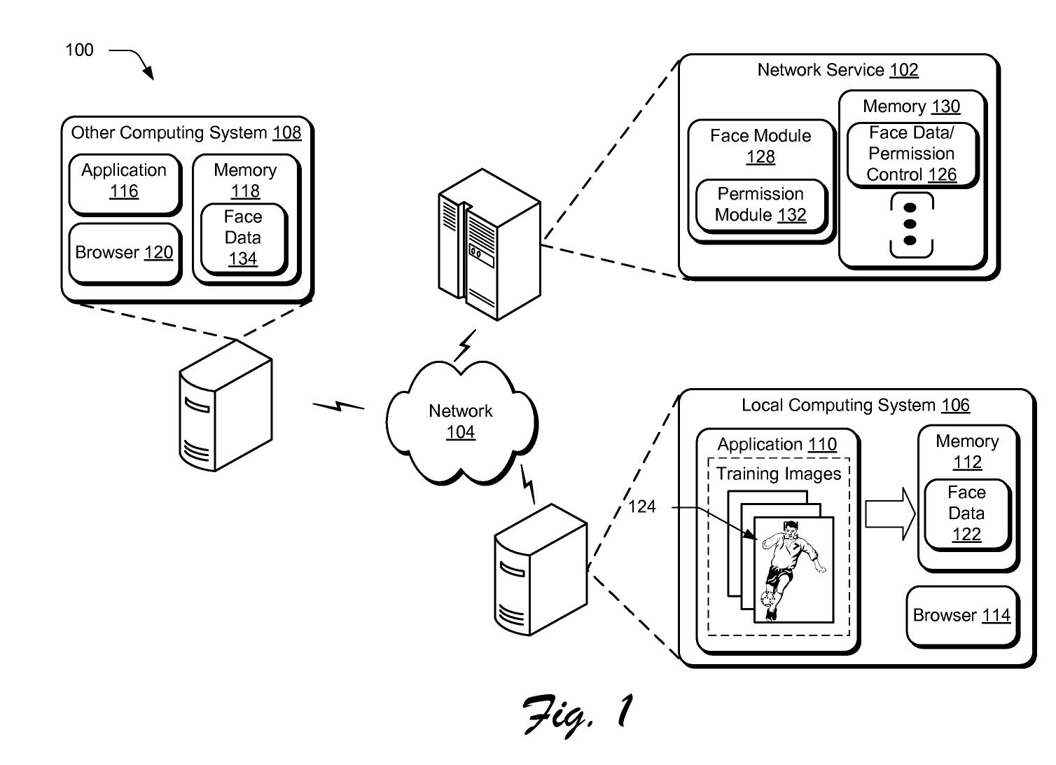

FIG. 1 is an illustration of an environment 100 in an example implementation that is operable to share face data and/or data that forms training images. As illustrated, the environment 100 includes one or more computing systems that are each coupled one-to-another and the network service 102 by a network 104. For convenience in the discussion only, one of the computing systems is referred to as the local computing system 106 and another computing system 108 is referred to as the other computing system 108.

As is to be apparent, each of the computing systems 106, 108 may be a client of the network service 102. For example, a user may employ the local computing system 106 to interact with the network service 102 in association with a user account. The user may access the network service 102 by entering account information, e.g., an identification and password for the account.

As illustrated, the local computing system 106 includes an application 110, memory 112, and a web browser (illustrated as browser 114). The other computing system 108 may be configured in a similar manner, e.g., an application 116, memory 118, and a browser 120.

The application 110 is representative of functionality to identify faces and additional information to a face in subject images, e.g., electronic photographs, files that include electronic images, and so on. For example, the application 110 may identify that a subject image is associated with a particular person by comparing face data from the subject image with face data from an image in which the particular person's face is identified with the name of the particular person.

A user may relate additional information to the face by entering the information to be identified as a tag using the application 110. For example, the application 110 may be configured to associate additional information, such as an ID, with the face. Thus, the additional information may be identified when a face in a subject image matches a face that is tagged. For example, a member ID may be identified when face data from a subject image is matched to the face data associated with the member ID.

Once the training images are tagged, a face recognition algorithm is used to calculate face data that represents characteristics of a face in an image, e.g., subject or training images. The face data may represent facial characteristics such as eye position, distance between the eyes, eye shape, nose shape, facial proportions, and so on. In implementations, the face recognition algorithm may calculate face vector data that mathematically represents characteristics of a face in an image. In other implementations, face data may be represented in templates use to match faces and so on. The tagging and training process may be repeated with additional images to increase the number of images that serve as a basis for the face data. For example, tagging training images may be an on-going process to increase the reliability of the face data that is used as an exemplar and so forth. Thus, the face data that serves as an exemplar may be refined with face data from additional training images such as when the face data from the additional images is sufficiently distinct to improve identification in comparison to the previously derived face data.

The application 110 may store the face data 122 for the training images in the memory 112 so it is discoverable by other computing systems. Various techniques may be used to make face data 112 discoverable, such as by providing an indication in a table, using a link, and so forth. Accordingly, the other computing system 108 may discover the face data although it may be stored in variety of locations in the memory 112.

In implementations, the local computing system 106 makes the face data discoverable by storing it in a well-defined location in the memory 112. A well-defined location may be promulgated as a standard, implement a standard methodology for determining where the face data is stored, and so forth. In this way, the other computing system 108 may discover and replicate the face data 122 and vice versa. For instance, the other computing system 108 may automatically synchronize with the well-defined location in order to replicate the face data for storage in the memory 118 of the other computing system 108 (which is illustrated as face data 134). Thus, the face data may be discovered by the application 116 and/or other computing systems.

In some instances, the computing systems may also share data that forms the training image itself in place of or in addition to the face data 122. By sharing the data that forms the training images, different face recognition algorithms may use the training images. Thus, application 116 may use a different face recognition algorithm from that used by the application 110.

The user may also share the face data 122 by uploading it to the network service 102. In this way, the user may access the face data on multiple computing systems and share the face data with other users. For instance, the user may upload the face data via a webpage maintained by the network service 102, have the local computing system upload it automatically, and so on.

The network service 102 is representative of functionality to share face data. The network service 102 may also store face data and/or perform facial recognition, e.g., over-the-cloud facial recognition using shared face data. Although the network service 102 is illustrated as a single server, multiple servers, data storage devices, and so forth may be used to provide the described functionality.

As illustrated, the network service 102 includes a face module 128 and memory 130, e.g., tangible memory. The face module 128 is representative of functionality to share face data and/or data that forms a training image. For example, the face module may act as an intermediary for the local and other computing systems 106, 108.

Once the face data is received, the face module 128 may store the face data 126 in association with a user account that provided it, in a common location, and so on. The face data may be stored in a common location in memory 130 (e.g., stored with face data from other users) to speed discovery and so forth. In implementations, the face data 126 may be stored in a directory that is hidden or obscured from the users to avoid unintended deletion or modification.

As further illustrated, the face module 128 includes a permission module 132. The permission module 132 represents functionality to control which users of the network service 102 may access the face data 126. The permission module 132 may set a permission expression that is included in a permission control that is combined with the face data. In this way, the permission module 132 may use the permission control to restrict access to the face data 126 based on setting in an account. The permission expression may restrict access to the user who provided the face data 126, contacts and friends of the user, each user of the network service 102, and so on.

The permission module 132 may also combine the face data 126 with an identification of a user account associated with the face data 126. For instance, the permission module 132 may include an identification of a user account that published the face data 126. By uniquely identifying the user account (and thus a user), the permission module 132 may allow a user to retain control over the face data 126.

In implementations, the permission module 132 allows a user to take over face data that represents the user. For example, the permission module 132 may replace an identification of a user account that published the face data 126 with an identification of a user account for a user who is represented by the face data 126. As a result, when a user joins the network service, the user may take over control of the user's face data.

For example, if Emily published face data for her friend Eleanor, Eleanor may take over control of the face data upon establishing a user account. In this way, Eleanor may control her face data and the permission module 132 may replace an identification for Emily's account with an identification of Eleanor's account. The foregoing account identification change may be done without changing the ID included in the face data, e.g. the face data may still serve as a basis to identify Eleanor. The permission module 132 may also replace permission expressions based on settings in Eleanor's account.

The take-over procedure may also be used to pre-populate Eleanor's account with her face data. In other instances, the network service 102 may allow a user who published the face data to opt-out from allowing another user to take-over control of the face data. For example, the network service 102 may force the user who published the face data 126 to restrict its use (e.g., to the user who published it) or delete the face data.

In other implementations, the user whose face is represented by the face data may be permitted to provide supplemental face data. For example, the permission module 132 may allow a user whose face is represented by the face data to publish supplemental face data to replace and/or augment face data that represents the person. In this fashion, the person may provide supplemental face data that permits more accurate identification of the person (in comparison to face data already stored with the network service 102), and so forth.

The network service 102 may perform other functions that may be used independently or in conjunction with sharing face data and over-the-cloud facial recognition. For example, the network service 102 may comprise a social network service that allows users to communicate, share information, and so on. A variety of other examples are also contemplated.

Although memories 112, 118, 130 are shown, a wide variety of types and combinations of memory (e.g., tangible memory) may be employed, such as random access memory (RAM), hard disk memory, removable medium memory, external memory, and other types of computer-readable storage media.

Generally, the functions described herein can be implemented using software, firmware, hardware (e.g., fixed logic circuitry), manual processing, or a combination of these implementations. The terms “module,” “functionality,” “service,” and “logic” as used herein generally represent software, firmware, hardware, or a combination of software, firmware, or hardware. In the case of a software implementation, the module, functionality, or logic represents program code that performs specified tasks when executed on a processor (e.g., CPU or CPUs). The program code may be stored in one or more computer-readable memory devices (e.g., one or more tangible media), and so on. The structures, functions, approaches, and techniques described herein may be implemented on a variety of commercial computing platforms having a variety of processors.

Processors are not limited by the materials from which it is formed or the processing mechanisms employed therein. For example, the processors may be comprised of semiconductor(s) and/or transistors (e.g., electronic integrated circuits (ICs)).

In additional embodiments, a variety of devices may make use of the structures, techniques, approaches, modules, and so on described herein. Example device include, but are not limited to, desktop systems, personal computers, mobile computing devices, smart phones, personal digital assistants, laptops, and so on. The devices may be configured with limited functionality (e.g., thin devices) or with robust functionality (e.g., thick devices). Thus, a device's functionality may relate to the device's software or hardware resources, e.g., processing power, memory (e.g., data storage capability), and so on.

Moreover, the local and other computing systems 106, 108 and the network service 102 may be configured to communicate with a variety of different networks. For example, the networks may include the Internet, a cellular telephone network, a local area network (LAN), a wide area network (WAN), a wireless network, a public telephone network, an intranet, and so on. Further, the network 104 may be configured to include multiple networks. Having provided an overview of the environment 100, example implementations using systems that may use the environment 100 and/or other environments are now described.

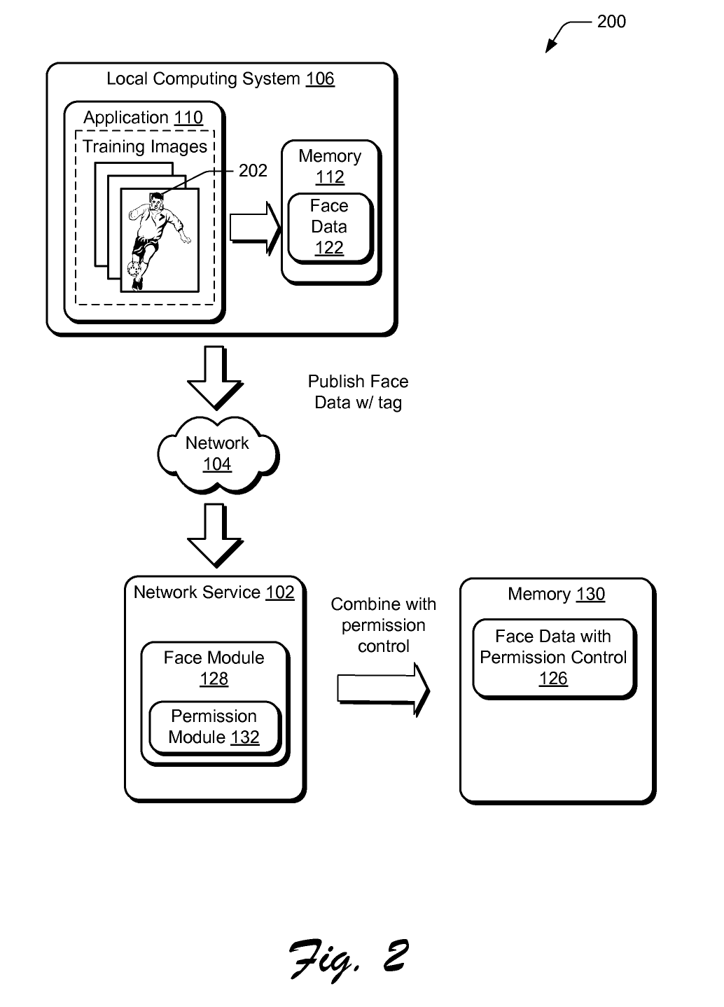

FIG. 2 depicts an example system 200 in which the local computing system 106 is used to publish face data 122. As illustrated, the application 110 includes functionality to tag a face 202 with additional information.

For example, a user may enter the name of a person in a tag with a graphic user interface (GUI) in the application 110. The user may select a face to be tagged and then enter the additional information that is to be related to the face. The application 110 may then store the face data and the additional information in a variety of ways in memory 112 so that it is discoverable. The additional information may be stored such as a tag (e.g., metadata) that describes the face data 122 and so on. In additional implementations, data that forms the training image 124 may be stored in the memory 112 so it is related to the face data, e.g., in a database, related in a table, and so on.

Once the training image is tagged, a face recognition algorithm is used to calculate the face data for the face that is tagged. The additional information may be included as a metadata tag for face data that represents the face 202.

The user may upload the face data 122 (manually or via an automatic procedure) to the network service 102 so other users may access the face data 122. For example, the user may permit other users of the network service 102 to identify the additional information using the face data.

Upon receiving the face data, the permission module 132 may combine the face data 126 with one or more of a permission control or an identification for the user's account for storage in memory 130. Thus, the user may select which other users may access to the face data 126 by selecting settings for the user's account.

In implementations, the face module 128 may include functionality to tag faces with additional information and/or calculate face data. In this way, the user may tag a face “over-the-cloud” using the web browser 114 to access a webpage supported by the face module 128. The face data from the now tagged image may then be stored in memory 130.

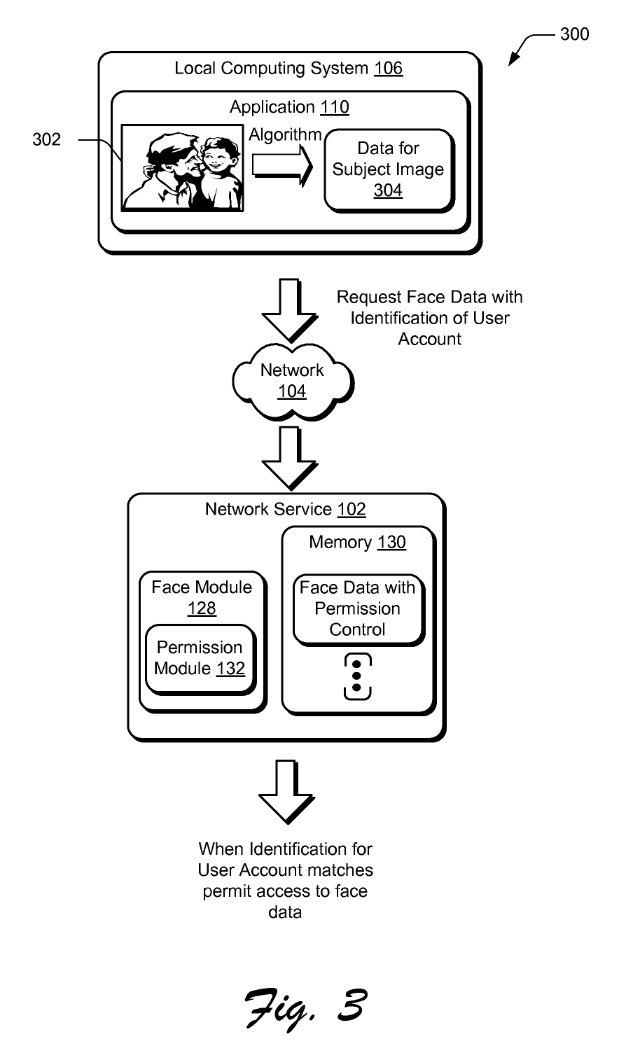

Having described how face data may be shared, discovery of face data is now discussed in conjunction with FIG. 3. As is to be appreciated, the approaches and techniques described in connection with FIG. 2 may be implemented independently or in connection with the approaches, techniques, and structures that are described with respect to FIG. 3.

FIG. 3 depicts an example system 300 in which the other computing system 108 may discover face data shared by the local computing system 106. For example, the application 116 may automatically transfer face data 126 from the network service 102. The other computing system 108 may also synchronize with the local computing system 106 to replicate the face data without performing tagging on the other computing system 108. The other computing system 108 may discover the face data using a link, looking-up the location of the face data in a table, and so on.

The application 116 may also automatically discover face data 126 to which the user is permitted access. For example, the application 116 may automatically check for face data that the user is allowed to access. In further examples, the application 116 may discover face data in response to a request to identify a face in a subject image, upon launching the application 116, have a regularly scheduled background task, and so on.

In instances in which the other computing system 108 transfers face data, the permission module 132 may compare an identification associated with the request with a permission expression to determine whether to grant access. The face module may then transfer the face data 126 to the other computing system 108 from which the request was received when the identification matches a user account that is allowed to transfer the face data, such as by downloading the face data.

Once the face data is stored in memory 118, the application 116 may use a face recognition algorithm to obtain face data for the subject image 304, e.g., an in-question image. The application 116 may identify the additional information when the face data for the subject image matches that of the training image.

Example Procedures

The following discussion describes procedures that may be implemented utilizing the previously described systems, techniques, approaches, services, and modules. Aspects of each of the procedures may be implemented in hardware, firmware, software, or a combination thereof. The procedures are shown as a set of blocks that specify operations performed by one or more devices (e.g., computing systems) and are not necessarily limited to the orders shown for performing the operations by the respective blocks. In portions of the following discussion, reference will be made to the environment 100 of FIG. 1 and the systems of FIGS. 2 and 3.

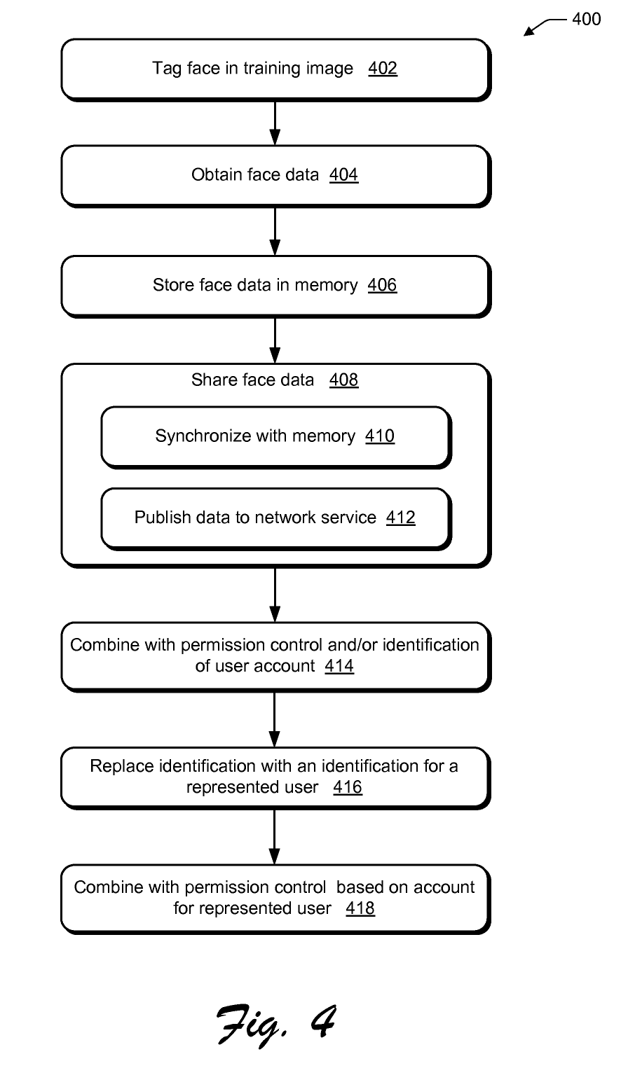

FIG. 4 depicts a procedure 400 in which face data and/or data that forms training images is shared among computing systems, and so forth. A face is tagged in a training image (block 402). A user may tag a face in a training image with addition formation, e.g., the name of the person whose face is tagged and so on.

Face data is also obtained from the training images (block 404). For example an application may use a face recognition algorithm to determine face data, such as face vector data, for the training image 124. The face data may represent facial characteristics of the face that was tagged and include the additional information in the tag. The additional information may be associated with the face data such that when the face data matches that of a subject image the additional information may be identified. For instance, the additional data may be included as metadata that describes the face data. In this way, the face data for the training image is used as an exemplar against which face data for a subject image is compared.

The face data is stored so that it is discoverable (block 406). For instance, the location of the face data in memory 112 may be indicated using a link or a table. In one or more embodiments, the face data is stored in a well-defined location in memory. A well-defined location may be promulgated according to a standard, discovered using a standard methodology, and so on.

The face data is shared (block 408). In an implementation, the face data is shared via a synchronization approach (block 410). For example, the other computing system 108 may synchronize with a well-defined location in memory 112 so the face data may be replicated in memory 118 without performing training on the other computing system 108. In other examples, face data that serves as an exemplar may be automatically synchronized when a user adds a contact or logs on to a computing system.

The face data 122 may also be published on a network service (block 412). Examples include automatically providing the face data 122 upon an occurrence of an event or manually uploading the face data via a webpage for the network service 102. For example, face data may be published when a user adds a contact to the user's address book.

The face data is combined with one or more of an identification for a user account or a permission control (block 414). For example, the permission module 132 may include an identification of a user account that published the face data. In further implementations, the network service 102 may combine a permission control with the face data.

In one or more embodiments, an identification for an user account may be replaced with an identification of an account for a user who is represented by the face data (block 416). For example, the network service 102 may allow a user to take-over control of the user's face data. In the previous example, the permission module 132 may replace the identification for one account with an identification of an account for the user who is represented by the face data.

In some embodiments, the network service combines a permission control with the face data (block 418). The permission control includes permission expressions set according to the account for the user who is represented by the face data. Having described stored the face data so that it is discoverable, discovery of face data that is available to be shared is now discussed.

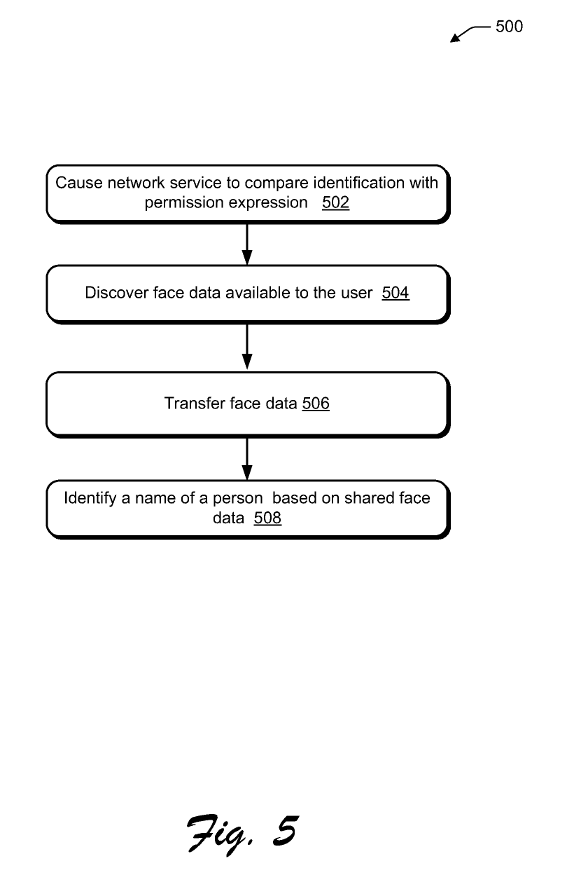

FIG. 5 depicts a procedure 500 in which face data is discovered. The procedure 500 may be used in conjunction with the approaches, techniques and procedure 400 described with respect to FIG. 4.

A network service is caused to compare an identification for a user account with a permission expression (block 502). For example, the permission module 132 may compare an identification associated with the request with a permission expression in a permission control for the face data. For instance, the permission module 132 may check to see if an identification associated with the request is included in a group of users that is permitted to transfer (e.g., download) the face data 126.

Face data is discovered that the user is permitted access (block 504). An application from which a request is received, for instance, is permitted access when the identification is allowed by the permission expression. Thus, a user may check the network service 102 to see what face data the user is permitted to access. In this way, the user may avoid training additional computing systems.

In one or more embodiments, the face data is transferred (block 508). For instance, face data may be transferred to the other computing system such that the application 116 may identify faces in subject images without performing training on the other computing system 108. In the previous instance, the other computing system 108 and the network service 102 may interact to transfer the face data upon the occurrence of an event (e.g., logging-in, adding a contact, at start-up), at a predetermined time interval, and so on.

A name of a person included in a tag is identified (block 508) when face data for a subject image matches face data for a training image tagged with the name of the person. For instance, the name “Bob Smith” is identified when face data for a subject image matches face data in which Bob Smith's face is tagged with his name. This may permit facial recognition without having to train a computing system or network service performing the recognition. Further, the face data may be used to locate subject images that include a particular person (e.g., find pictures of Bob Smith) and so forth.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
discovering, in memory on a computing system, face data for a training image that includes a tag associated with a face; and
replicating the face data in a location in memory, on another computing system, so the face data is discoverable.

2. A computer-implemented method as described in claim 1, further comprising identifying the tag by comparing face data for a subject image with the face data on the other computing system to identify the tag when the face data for the subject image matches the face data from the computing system.

3. A computer-implemented method as described in claim 2, wherein the identifying is performed without training on the other computing system.

4. A computer-implemented method as described in claim 1, wherein the face data for the training image mathematically represents a face included in the training image.

5. A computer-implemented method as described in claim 1, wherein the discovering occurs automatically.

6. A computer-implemented method as described in claim 1, wherein the tag comprises one or more of:
a name of a person associated with the face,
an electronic mail address associated with the face, or
an identification (ID) that identifies the person associated with the face.

7. A computer-implemented method comprising:
publishing face data on a network service, the face data being associated with a user account and is usable to identify a person based on a facial characteristic for a face represented by the face data; and
controlling access to the face data with a permission expression that specifies which users are permitted to access the face data to identify the person.

8. A computer-implemented method as described in claim 7, further comprising associating an identification for the user account with the face data to identify a user who published the face data.

9. A computer-implemented method as described in claim 8, further comprising replacing the identification for the user account with an identification of a user account for the person represented by the face.

10. A computer-implemented method as described in claim 9, wherein which users of the network service are granted access to the face data is controlled based on a permission expression set accordance with the user account for the person represented by the face.

11. A computer-implemented method as described in claim 7, further comprising accepting supplemental face data, from the person represented by the face, that corresponds to the face data.

12. A computer-implemented method as described in claim 7, further comprising storing the face data in association with the user account.

13. A computer-implemented method as described in claim 7, wherein the face data is accessible by an application on a client computing system on behalf of a user.

14. One or more computer-readable media comprising instructions that are executable to:
cause a network service to compare an identification for a user account with a permission expression that controls access to face data responsive to a request for the face data in association with the user account, the face data including an identification (ID) for a person whose face is represented by the face data;
discover the face data made available to the user account; and
identify the ID for the person when face data for a subject image matches the face data that includes the ID.

15. One or more computer-readable media as described in claim 14, wherein the identification is performed on a computing system or service that made the request.

16. One or more computer-readable media as described in claim 14, wherein the permission expression is set based on settings in a user account that published the face data.

17. One or more computer-readable media as described in claim 14, wherein the face data mathematically represents the face that is included in one or more training images.

18. One or more computer-readable media as described in claim 14, wherein the instructions are further executable to cause the network service to store data from the subject image.

19. One or more computer-readable media as described in claim 14, wherein the instructions are further executable to cause the face data for the training image to be transferred to a computing system associated with the request.

20. One or more computer-readable media as described in claim 14, wherein the discover the face data is performed automatically by an application on a client computing system.
